(19) United States
(12) Patent Application Publication
(10) Pub. No.: US 2011/0241766 A1
(43) Pub. Date: Oct. 6, 2011

(54) CHARGE PUMP

(75) Inventors: Lei Zhang, Jiangsu (CN); Deming Tang, Jiangsu (CN)

(73) Assignee: Jiangsu Lexvu Electronics Co., Ltd., Jiangsu (CN)

(21) Appl. No.: 12/846,415

(22) Filed: Jul. 29, 2010

(30) Foreign Application Priority Data
Apr. 2, 2010 (CN) 201020153156.0

(51) Int. Cl. G05F 3/02

(52) U.S. Cl. 327/536

(57) ABSTRACT

A charge pump includes a first voltage input node, a second voltage input node, a voltage output node, at least a flying capacitor, an energy reserve capacitor, a first MEMS switches group controlled by a controlling signal, a second MEMS switches group controlled by the controlling signal, a third MEMS switches group controlled by the controlling signal and a forth MEMS switches group controlled by the controlling signal. The flying capacitor is connected with the first voltage input node and the second voltage input node via the first MEMS switches group. The flying capacitor is connected with the first voltage input node or the second voltage input node via the second MEMS switches group. The energy reserve capacitor is connected with the flying capacitor via the third MEMS switches group. The energy reserve capacitor is connected with the voltage output node and the second voltage input node. When a clock controls the first MEMS switches group to turn on, and the second MEMS switches group and the third MEMS switches group to turn off, the flying capacitor is charged up through the first voltage input node and the second voltage input node. When the clock controls the first MEMS switches group to turn off, and the second MEMS switches group and the third MEMS switches group to turn on, the energy reserve capacitor is charged up through the flying capacitor and the second voltage input node. Through MEMS technology, miniaturization and integration of the charge pump are achieved, and power consumption is reduced, and energy conversion efficiency is improved.

### CROSS REFERENCE TO RELATED APPLICATIONS

The present application claims the priority of Chinese Patent Application No. 201020153156.0, entitled “CHARGE PUMP”, and filed Apr. 2, 2010, the entire disclosure of which is incorporated herein by reference.

### FIELD OF THE INVENTION

The present invention relates to a voltage converter, particularly to a charge pump.

### BACKGROUND OF THE INVENTION

A charge pump is a DC/DC converter utilizing a flying capacitor (instead of an inductor or a transformer) for energy storage. Transistor switch array controls the flying capacitor to charge or to discharge in a certain manner, so that input voltage is increased or decreased by a factor (for example, −1, 0.5, 2, 3), thereby obtaining a desirable output voltage. There are lots of circuits for the charge pump in the prior art, such as a charge pump of the Chinese patent application No.02815860.1.

FIG. 1 schematically illustrates a circuit of a conventional charge pump for raising output to doubled voltage of input in the prior art. The conventional charge pump comprises a voltage input node Vin, a voltage output node Vout, a flying capacitor CF and an energy reserve capacitor CR. A voltage source provides an input voltage for the charge pump through the voltage input node Vin. The voltage output node Vout is used for driving an output voltage to a corresponding load. The flying capacitor CF is serially connected between the voltage input node Vin and ground via switches S1, S2. A first electrode plate 11 of the flying capacitor CF is electrically connected with the voltage input node Vin via the switch S1. A second electrode plate 12 of the flying capacitor CF is connected with ground via the switch S2. The second electrode plate 12 of the flying capacitor CF is connected with the voltage input node Vin via a switch S4. The energy reserve capacitor CR is serially connected between the voltage output node Vout and ground. A first electrode plate 21 of the energy reserve capacitor CR is connected with the voltage output node Vout, and a second electrode plate 22 of the energy reserve capacitor CR is connected with ground, thereby providing the output voltage for the corresponding load. The first electrode plate 21 of the energy reserve capacitor CR is connected with the first electrode plate 11 of the flying capacitor CF via a switch S3. A clock controls the switches S1, S2, S3 and S4 to turn on or to turn off, wherein the switches S1, S2 turn on or turn off simultaneously and the switches S3, S4 turn on or turn off simultaneously. When the clock controls the switches S1, S2 to turn on and the switches S3, S4 to turn off, a voltage source of voltage V charges up the flying capacitor CF to voltage V through the voltage input node Vin. When the clock controls the switches S1, S2 to turn off and the switches S3, S4 to turn on, and the potential of the flying capacitor CF is raised by voltage V, namely from voltage V to voltage 2V. Thus, the voltage across the energy reserve capacitor CR is 2V and the voltage of the voltage output node is 2V, thereby raising the output voltage to two times of the input voltage.

Whereas, the switches which are used for the conventional charge pump described above are transistor switches formed by MOS technology, such as thin film transistor (TFT), Field Effect Transistor (FET) etc. Since a transistor has a gate, a source and a drain and the transistor is influenced by technology factors of design rules, critical dimension (CD) and layout etc, the transistor occupies necessary layout areas thereby restricting miniaturization and integration of the charge pump.

### SUMMARY OF THE INVENTION

An object of the present invention is to provide a charge pump which can decrease layout areas to achieve miniaturization and integration.

To achieve the object, the present invention provides a charge pump comprising a first voltage input node, a second voltage input node, a voltage output node, at least one flying capacitor, an energy reserve capacitor, a first MEMS switches group controlled by a control signal, a second MEMS switches group controlled by the control signal and a third MEMS switches group controlled by the control signal. The energy reserve capacitor is connected with the voltage output node and the second voltage input node. The first MEMS switches group controlled by a control signal is adapted for connecting the at least one flying capacitor with both of the first voltage input node and the second voltage input node. The second MEMS switches group controlled by the control signal is adapted for connecting the at least one flying capacitor with either of the first voltage input node and the second voltage input node. The third MEMS switches group controlled by the control signal is adapted for connecting the energy reserve capacitor with the at least one flying capacitor. The flying capacitor is charged through the first voltage input node and the second voltage input node when the control signal controls the first MEMS switches group to turn on, and the second MEMS switches group and the third MEMS switches group to turn off. The energy reserve capacitor is charged through the flying capacitor and the second voltage input node when the control signal controls the first MEMS switches group to turn off, and the second MEMS switches group and the third MEMS switches group to turn on.

Optionally, the at least one flying capacitor comprises one flying capacitor. The first MEMS switches group comprises a first MEMS switch for connecting a first electrode plate of the flying capacitor with the first voltage input node, and a second MEMS switch for connecting a second electrode plate of the flying capacitor with the second voltage input node. The second MEMS switches group comprises a third MEMS switch for connecting the second electrode plate of the flying capacitor with the first voltage input node. The third MEMS switches group comprises a forth MEMS switch for connecting a first electrode plate of the energy reserve capacitor with the first electrode plate of the flying capacitor. The first electrode plate of the energy reserve capacitor is connected with the voltage output node. A second electrode plate of the energy reserve capacitor being connected with the second voltage input node.

Optionally, the at least one flying capacitor comprises one flying capacitor. The first MEMS switches group comprises a first MEMS switch for connecting a first electrode plate of the flying capacitor with the first voltage input node, and a second MEMS switch for connecting a second electrode plate of the flying capacitor with the second voltage input node. The second MEMS switches group comprises a third MEMS switch for connecting the second electrode plate of the flying capacitor with the second voltage input node. The third MEMS switches group comprises a forth MEMS switch for connecting a first electrode plate of the energy reserve capacitor with the second electrode plate of the flying capacitor. The first electrode plate of the energy reserve capacitor is connected with the voltage output node. A second electrode plate of the energy reserve capacitor is connected with the second voltage input node.

Optionally, the at least one flying capacitor comprises a first flying capacitor and a second flying capacitor. The first MEMS switches group comprises a first MEMS switch for connecting a first electrode plate of the first flying capacitor with the first voltage input node, a second MEMS switch for connecting a second electrode plate of the first flying capacitor with a first electrode plate of the second flying capacitor, and a third MEMS switch for connecting a second electrode plate of the second flying capacitor with the second voltage input node. The second MEMS switches group comprises a forth MEMS switch for connecting the second electrode plate of the first flying capacitor with the first voltage input node, and a fifth MEMS switch for connecting the second electrode plate of the second flying capacitor with the first voltage input node. The third MEMS switches group comprises a sixth MEMS switch for connecting a first electrode plate of the energy reserve capacitor with the first electrode plate of the first flying capacitor, and seventh MEMS switch for connecting the first electrode plate of the energy reserve capacitor with the first electrode plate of the second flying capacitor. The first electrode plate of the energy reserve capacitor is connected with the voltage output node and a second electrode plate of the energy reserve capacitor is connected with the second voltage input node.

Compared with the prior art, the present invention has the following advantages.

The MEMS switch has a simple structure and is less influenced by process factors, thus high voltage switch can be achieved by a standard process. The MEMS switch may be integrated with a circuit component manufactured by the standard process, and achieve low cost and integration of the charge pump.

What is more, in the embodiment of the present invention, each of MEMS switches may be arranged in a vertically overlapped fashion, further decreasing the areas of switch arrays, improving integrations of the charge pumps, and saving the areas of the chip.

The MEMS switches have low contact resistance, thereby reducing consumption and improving energy conversion efficiency. When the MEMS switches switch inactively (the on-state), no power is consumed substantially, thus entire power consumption of the charge pump can be reduced.

The switching frequency of the MEMS switches may be very high, thus the capacitance of the flying capacitor may be very small during each charging process, whereby a voltage source of small voltage is allowable, reducing the power consumption of the charge pump.

### BRIEF DESCRIPTION OF THE DRAWINGS

FIG. 1 schematically illustrates a circuit of a conventional charge pump for raising output to doubled voltage of input in the prior art;

FIG. 2 schematically illustrates a circuit of a charge pump for raising output to doubled voltage of input in a first embodiment of the present invention;

FIG. 3 schematically illustrates a circuit of a charge pump for converting the output to opposite voltage of input in a second embodiment of the present invention;

FIG. 4 schematically illustrates a circuit of a charge pump for raising output to 1.5 times voltage of input in a third embodiment of the present invention;

FIG. 5 is a side structural diagram for a MEMS switch in an embodiment of the present invention;

FIG. 6 is a side structural diagram for a first MEMS switches group of the charge pump for raising output to doubled voltage of input in the first embodiment of the present invention; and

FIG. 7 is a top view for a MEMS switch of the charge pump for raising output to doubled voltage of input in the first embodiment of the present invention.

### DETAILED DESCRIPTION OF THE EMBODIMENTS

A charge pump of the present invention substitutes transistors with MEMS (Micro Electro Mechanical systems) switches to merge MEMS switches together.

MEMS technology is an advanced technology based on micro/nanotechnology in 21 century and a designing, processing, manufacturing, measuring and controlling technology for micro/nanomaterial. The MEMS technology utilizes a manufacturing technology incorporating micro-electronic technique and micro-fabrication technique, which integrates mechanical element, optical system, driver component and electrical control system to form an entire micro system. The MEMS switch is one of applications of the MEMS technology and a super-micro mechanical switch formed with semiconductor silicon manufacturing technology.

A charge pump in accordance with the present invention comprises a first voltage input node, a second voltage input node, a voltage output node, at least one flying capacitor, an energy reserve capacitor, a first MEMS switches group controlled by a control signal, a second MEMS switches group controlled by the control signal, and a third MEMS switches group controlled by the control signal. The flying capacitor is connected with both of the first voltage input node and the second voltage input node via the first MEMS switches group. The flying capacitor is connected with either of the first voltage input node and the second voltage input node via the second MEMS switches group. The energy reserve capacitor is connected with the flying capacitor via the third MEMS switches group. The energy reserve capacitor is connected with the voltage output node and the second voltage input node. When the control signal controls the first MEMS switches group to turn on, and the second MEMS switches group and the third MEMS switches group to turn off, the flying capacitor is charged up through the first voltage input node and the second voltage input node. When the control signal controls the first MEMS switches group to turn off, and the second MEMS switches group and the third MEMS switches group to turn on, the energy reserve capacitor is charged up through the flying capacitor and the second voltage input node. In the embodiment of the present invention, the control signal is a clock.

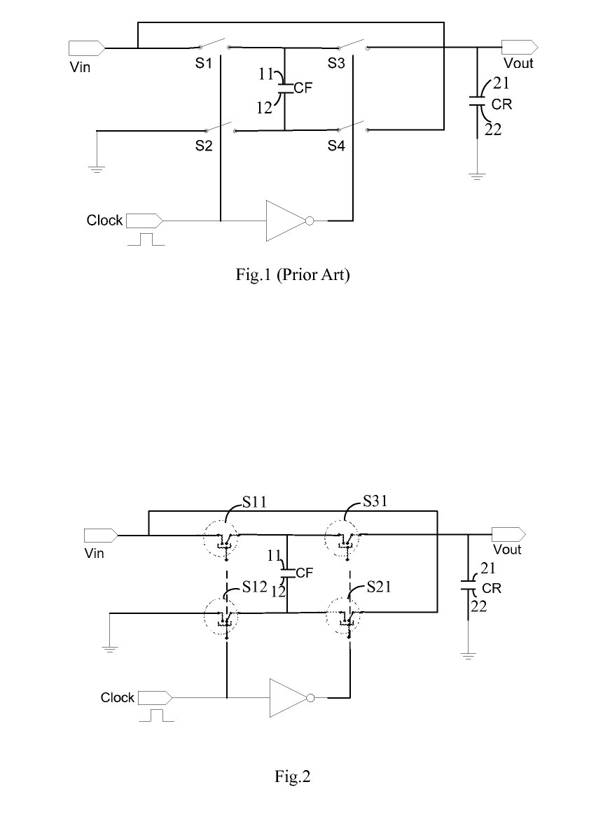

Referring to FIG. 2, a charge pump according to a first embodiment of the present invention comprises a first voltage input node Vin, a second voltage input node, a voltage output node Vout, a flying capacitor CF, an energy reserve capacitor CR and MEMS switches groups. The flying capacitor CF comprises a first electrode plate 11 and a second electrode plate 12. The energy reserve capacitor CR comprises a first electrode plate 21 and a second electrode plate 22. A first MEMS switches group comprises a first MEMS switch S11 and a second MEMS switch S12. A second MEMS switches group comprises a third MEMS switch S21. A third MEMS switches group comprises a forth switch S31. The first electrode plate 11 of the flying capacitor CF is connected with the first voltage input node Vin via the first MEMS switch S11. The second electrode plate 12 of the flying capacitor CF is connected with the second voltage input node via the second MEMS switch S12. The second electrode plate 12 of the flying capacitor CF is connected with the first voltage input node Vin via the third MEMS switch S21. In the present embodiment, the second voltage input node is a common ground node. The first electrode plate 21 of the energy reserve capacitor CR is connected with the first electrode plate 11 of the flying capacitor CF via the forth switch S31. The first electrode plate 21 of energy reserve capacitor CR is connected with a voltage output node Vout. The second electrode plate 22 of the energy reserve capacitor CR is connected with the second voltage input node to provide output voltage for a load. A clock (the control signal) controls the switches S11, S12, S21 and S31 to turn on or to turn off, wherein the switches S11, S12 turn on or turn off simultaneously and the switches S21, S31 turn on or turn off simultaneously. When the clock controls the switches S11, S12 to turn on and the switches S21, S31 to turn off, a voltage source of voltage V charges up the flying capacitor CF to voltage V through the voltage input node Vin, then the clock controls the switches S11, S12 to turn off and the switches S21, S31 to turn on, and the potential of the flying capacitor CF is raised by voltage V, namely from voltage V to voltage 2V. Thus voltages across the energy reserve capacitor CR are 2V and the voltage of the voltage output node is 2V, thereby raising the output voltage to two times of the input voltage.

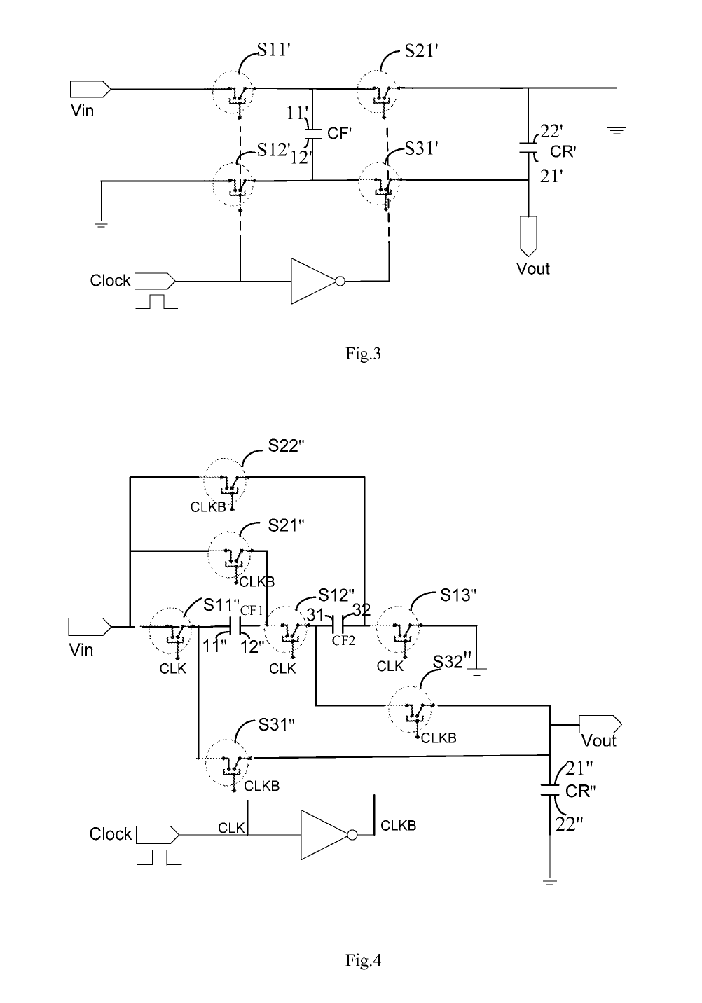

Referring to FIG. 3, a charge pump according to a second embodiment of the present invention comprises a first voltage input node Vin, a second voltage input node, a voltage output node Vout, a flying capacitor CF′, an energy reserve capacitor CR′, a first MEMS switches group, a second MEMS switches group and a third MEMS switches group. The flying capacitor CF′ comprises a first electrode plate 11′ and a second electrode plate 12′. The energy reserve capacitor CR′ comprises a first electrode plate 21′ and a second electrode plate 22′. The first MEMS switches group comprises a first MEMS switch S11′ and a second MEMS switch S12′. The second MEMS switches group comprises a third MEMS switch S21′. The third MEMS switches group comprises a forth switch S31′. The first electrode plate 11′ of the flying capacitor CF′ is connected with the first voltage input node Vin via the first MEMS switch S11′. The second electrode plate 12′ of the flying capacitor CF′ is connected with the second voltage input node via the second MEMS switch S 12′. The first electrode plate 11′ of the flying capacitor CF′ is connected with the second voltage input node via the third MEMS switch S21′. Preferably, the second voltage input node is a common ground node. The first electrode plate 21′ of energy reserve capacitor CR′ is connected with the second electrode plate 12′ of the flying capacitor CF′ via the forth switch S31′. The first electrode plate 21′ of energy reserve capacitor CR′ is connected with the voltage output node Vout. The second electrode plate 22′ of the energy reserve capacitor CR′ is connected with the second voltage input node. A clock controls the switches S11′, S12′, S21′ and S31′ to turn on or to turn off, wherein the switches S11′, S12′ turn on or turn off simultaneously and the switches S21′, S31′ turn on or turn off simultaneously. When the clock controls the switches S11′, S12′ to turn on and the switches S21, S31 to turn off, a voltage source of voltage V charges up the flying capacitor CF′ to voltage V through the voltage input node Vin. The clock controls the switches S11′, S12′ to turn off and the switches S21′, S31′ to turn on, and the potential of the flying capacitor CF′ is reversed, namely from voltage V to voltage −V. Thus voltage across the energy reserve capacitor CR is −V and voltage of the voltage output node is −V, thereby converting the output voltage opposite of input voltage.

In charge pumps according to embodiments of the present invention, the number of flying capacitors is not restricted to one, thereby raising or lowering output voltage to various times of input voltage.

Referring to FIG. 4, a charge pump according to a third embodiment comprises a first voltage input node Vin, a second voltage input node, a voltage output node Vout, two flying capacitors, an energy reserve capacitor CR″, a first MEMS switches group, a second MEMS switches group and a third MEMS switches group. The two flying capacitors comprise a first flying capacitor CF1 and a second capacitor CF2. The first flying capacitor CF1 comprises a first electrode plate 11″ and a second electrode plate 12″. The second flying capacitor CF2 comprises a first electrode plate 31 and a second electrode plate 32. The energy reserve capacitor CR″ comprises a first electrode plate 21″ and a second electrode plate 22″. The first MEMS switches group comprises a first MEMS switch S11″, a second MEMS switch S12″ and a third MEMS switch S13″. The second MEMS switches group comprises a forth MEMS switch S21″ and a fifth MEMS switch S22″. The third MEMS switches group comprises a sixth switch S31″ and a seventh switch S32″. The first electrode plate 11″ of the first flying capacitor CF1 is connected with the first voltage input node Vin via the first MEMS switch S11″. The second electrode plate 12″ of the first flying capacitor CF1 is connected with the first electrode plate 31 of the second flying capacitor CF2 via the second MEMS switch S12″. The second electrode plate 12″ of the first flying capacitor CF1 is connected with the first voltage input node Vin via the fourth MEMS switch S21″. The second electrode plate 32 of the flying capacitor CF2 is connected with the second voltage input node via the third MEMS switch S13″. The second electrode plate 32 of the flying capacitor CF2 is connected with the first voltage input node Vin via the fifth MEMS switch S22″. In the present embodiment, the second voltage input node is a common ground node. The first electrode plate 21″ of energy reserve capacitor CR″ is connected with the first electrode plate 11″ of the first flying capacitor CF1 via the sixth switch S31″. The first electrode plate 21″ of the energy reserve capacitor CR″ is connected with the voltage output node Vout. The first electrode plate 21″ of energy reserve capacitor CR″ is connected with the first electrode plate 31 of the flying capacitor CF2 via the seventh switch S32″. The second electrode plate 22″ of energy reserve capacitor CR″ is connected with the second voltage input node. A clock controls the switches S11″, S12″, S13″, S21″, S22″, S31″ and S32″ to turn on or to turn off. When a clock CLK is input, the switches S11″, S12″ and S13″ turn on or turn off simultaneously, and the switches S21″, S22″, S31″ and S32″ turn on or turn off simultaneously. When the clock CLK is effective (e.g. CLK is a high level), the switches S11″, S12″ and S13″ turn on simultaneously. When a clock CLKB is effective (e.g. CLKB is a high level), the switches S21″, S22″, S31″ and S32″ turn on simultaneously. When the switches S11″, S12″ and S13″ turn on and the switches S21″, S22″, S31″ and S32″ turn off, a voltage source of voltage V charges up the first flying capacitor CF1 and the second flying capacitor CF2 through the voltage input node Vin. When the switches S11″, S12″ and S13″ turn off and the switches S21″, S22″, S31″ and S32″ turn on, the first flying capacitor CF1 and the second flying capacitor CF2 are connected in parallel between the first voltage input node Vin and the voltage output node Vout. Since voltages across a capacitor can not be abruptly changed, the voltage of the voltage output node Vout is 1.5V.

Referring to FIG. 5, each MEMS switch comprises a first electrode E1 and a second electrode E2. The first electrode E1 comprises a first node n1 and a second node n2. The first node n1 and the second node n2 are used as two contact nodes of the switch respectively. The second electrode E2 comprises an electrical conductor n0. When a potential difference is applied between the first electrode E1 and the second electrode E2, the second electrode E2 moves relative to the first electrode E1 until the electrical conductor n0 of the second electrode E2 contacts the first node n1 and the second node n2 of the first electrode E1, thereby electrically connecting the first node n1 and the second node n2. The MEMS switch is in a turn-on state at this time. When no potential difference is applied between the first electrode E1 and the second electrode E2, the first electrode E1 moves relative to the second electrode E2. The electrical conductor n0 moves away from the first node n1 and the second node n2 of the first electrode E1, electrically disconnecting the first node n1 from the second node n2. The MEMS switch is in a turn-off state.

Referring to FIG. 5 again, the first electrode E1 of the MEMS switch is formed on a base board 30. The base board 30 comprises a substrate 30a (e.g. Silicon substrate) and a first insulating layer 30b (e.g. silicon dioxide insulating layer) on the surface of the substrate 30a. A trench is formed in the insulating layer 30b. The first electrode E1 comprises a first electrode plate E11 (e.g. aluminum electrode plate), the first node n1 and the second node n2 which are insulated from each other. The first electrode plate E11 is formed on the surface of the first insulating layer 30b. The first node n1 and the second node n2 are formed on the side of the trench of the insulating layer 30b.

Referring to FIG. 5 again, the first electrode E1 and the second electrode E2 are relatively arranged. The second electrode E2 comprises a second electrode plate E21 (e.g. aluminum electrode plate), the electrical conductor n0 and a second insulating layer 31a (e.g. silicon nitride insulating layer). The second electrode plate E21 and the electrical conductor n0 are insulated from each other through the second insulating layer 31a. The first electrode plate E11 and the second electrode plate E21 relatively arranged. The second insulating layer 31a is formed on the surface of the second electrode plate E21 and corresponds to the first electrode plate E11, exposing the surface E21a of the second electrode plate E21 corresponding to the first electrode plate E11. There is a vertical distance h from the electrical conductor n0 to the first node n1 and the second node n2 of the first electrode E1. When the MEMS switch is turned off, the electrical conductor n0 does not contact the first node n1 and the second node n2. When the MEMS switch is turned on, the electrical conductor n0 contacts the first node n1 and the second node n2, and the first node n1 electrically connects with the second node n2.

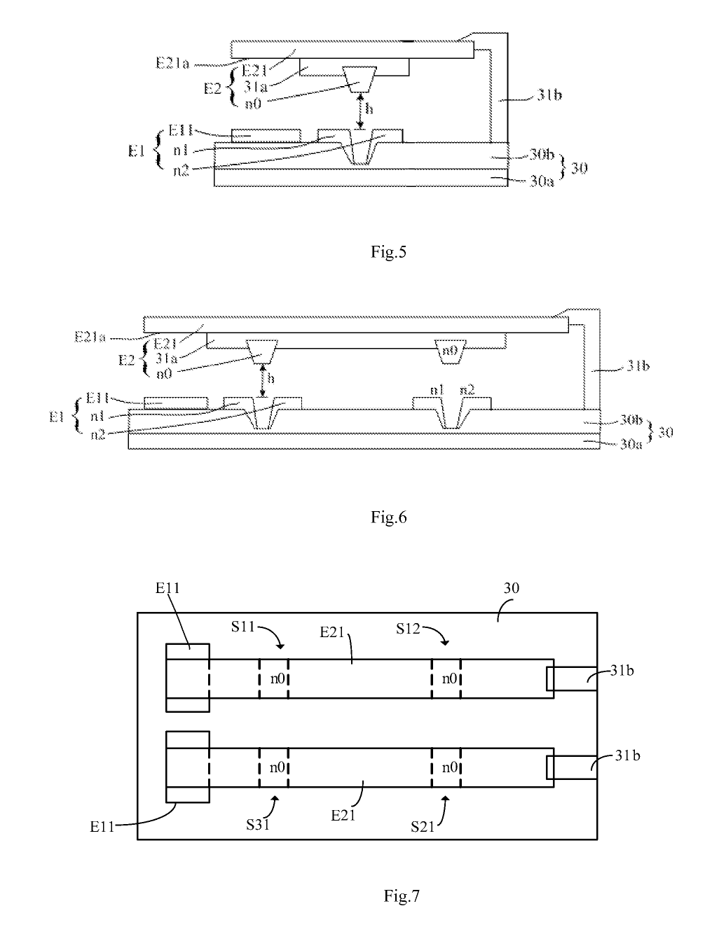

FIG. 6 is a side structural diagram for a first MEMS switches group of charge pump for raising output to doubled voltage of input in an embodiment of the present invention. In the embodiment of the present invention, the first MEMS switch and the second MEMS switch turn on or turn off simultaneously, and may be formed in the same row and controlled by the same clock. A third MEMS switch and a fourth MEMS switch turn on or turn off simultaneously, and may be formed in the same row and controlled by the same clock. Synchronism for turning on or turning off the MEMS switches can be improved in such way. A second electrode of the first MEMS switch and a second electrode of the second MEMS switch are formed on the same first electrode plate E11. A second electrode of the third MEMS switch and a second electrode of the fourth MEMS switch are formed on the same second electrode plate E21. When a voltage is applied to the second electrode plate E21 or the first electrode plate E11 by the clock, and potential difference is applied between the second electrode plate E21 and the first electrode plate E11, the second electrode plate E21 and the first electrode plate E11 attract each other due to electrostatic interaction, whereby the electrical conductor n0 of the first MEMS switch and the electrical conductor n0 of the second MEMS switch contact the first node n1 and the second node n2. The first node n1 is electrically connected with the second node n2. The first MEMS switch and the second MEMS switch turn on, and a voltage source charge up the flying capacitor through the voltage input node Vin. When the clock stops applying the voltage to the second electrode plate E21 or the first electrode plate E11 after finishing the charge process, the electrostatic interaction between the second electrode plate E21 and the first electrode plate E11 is eliminated, and the second electrode plate E21 restores the original position. The electrical conductor n0 does not contact the first node n1 and the second node n2, and the first node n1 is not electrically connected with the second node n2. The first MEMS switch and the second MEMS switch turn off.

Referring to FIG. 6 and FIG. 7, in an embodiment, the second electrode plate E21 is connected to the base board 30 through a support element 31b, thus the second electrode plate E21 may move relatively to the base board 30. When the clock turns on the first MEMS switch S11 and the second MEMS switch S12, the second electrode plate E21 moves relative to the base board 30, that is, the second electrode E2 of the first MEMS switch S11, the second electrode E2 the second MEMS switch S12 and moves close to the first electrode E1. The electrical conductor n0 electrically connects the first node n1 with the second node n2. When the clock turns off the first MEMS switch S11 and the second MEMS switch S12, the second electrode plate E21 moves away from the base board 30.

In other embodiments, each of MEMS switches of the first MEMS switches group is arranged in a vertically overlapped fashion. In the case of the four MEMS switches of the charge pump for raising output to doubled voltage of input in the embodiment, the second MEMS switch is formed above the first MEMS switch. Each of MEMS switches of the second MEMS switches group and each of MEMS switches of the third MEMS switches group are arranged in a vertically overlapped fashion, such as the four MEMS switches of the charge pump for raising output to doubled voltage of input in the embodiment, the fourth MEMS switch being formed above the third MEMS switch.

Each of MEMS switches of the first MEMS switches group, each of MEMS switches of the second MEMS switches group and each of MEMS switches of the third MEMS switches group are arranged in a vertically overlapped fashion. such as the four MEMS switches of the charge pump for raising output to doubled voltage of input in the embodiment, the second MEMS switch is formed above the first MEMS switch, and the third MEMS switch is formed above the second MEMS switch, and the fourth MEMS switch is formed above the third MEMS switch. In order for understanding and interpreting, only the vertically overlapped fashion form for each of MEMS switches is listed here. The order for MEMS switches may be freely arranged.

In an embodiment for a charge pump with other factor, the second electrodes of each MEMS switch of the first MEMS switches group are formed on the same first electrode plate, and the second electrodes of each MEMS switch of the second MEMS switches group and the third MEMS switches group are formed on the same second electrode plate. Optionally, each of MEMS switches of the first MEMS switches group is arranged in a vertically overlapped fashion, and each of MEMS switches of the second MEMS switches group is arranged in a vertically overlapped fashion, and each of MEMS switches of the third MEMS switches group is arranged in a vertically overlapped fashion. Optionally, each of MEMS switches of the first MEMS switches group, each of MEMS switches of the second MEMS switches group and each of MEMS switches of the third MEMS switches group are arranged in a vertically overlapped fashion.

A charge pump of the present invention substitutes transistors with MEMS switches. The MEMS switch has a simple structure and is less influenced by process factors, thus high voltage switch can be achieved by a standard process. The MEMS switch may be integrated with a circuit component manufactured by the standard process, and achieve low cost and integration of the charge pump. Further, each of MEMS switches may be arranged in a vertically overlapped fashion, further decreasing the areas of switch arrays, improving integrations of the charge pump, and saving the areas of the chip.

The MEMS switches have low contact resistance, thereby reducing consumption and improving energy conversion efficiency. When the MEMS switches switch inactively (the on-state), no power is consumed substantially, thus entire power consumption of the charge pump can be reduced.

The switching frequency of the MEMS switches may be very high, thus the capacitance of the flying capacitor may be very small during each charging process, whereby a voltage source of small voltage is allowable, reducing the power consumption of the charge pump.

Apparently, those skilled in the art should recognize that various variations and modifications can be made without departing from the spirit and scope of the present invention. Therefore, if these variations and modifications fall into the scope defined by the claims of the present invention and its equivalents, then the present invention intends to cover these variations and modifications.

What is claimed is:

1. A charge pump comprising:
a first voltage input node;
a second voltage input node;
a voltage output node;
at least one flying capacitor;
an energy reserve capacitor connected with the voltage output node and the second voltage input node;
a first MEMS switches group controlled by a control signal for connecting the at least one flying capacitor with both of the first voltage input node and the second voltage input node;
a second MEMS switches group controlled by the control signal for connecting the at least one flying capacitor with either of the first voltage input node and the second voltage input node;
a third MEMS switches group controlled by the control signal for connecting the energy reserve capacitor with the at least one flying capacitor;
the at least one flying capacitor being charged through the first voltage input node and the second voltage input node when the control signal controls the first MEMS switches group to turn on, and controls the second MEMS switches group and the third MEMS switches group to turn off; and
the energy reserve capacitor being charged through the flying capacitor and the second voltage input node when the control signal controls the first MEMS switches group to turn off, and controls the second MEMS switches group and the third MEMS switches group to turn on.

2. The charge pump according to claim 1, wherein each of MEMS switches comprises a first electrode and a second electrode, the first electrode comprising a first node and a second node, the second electrode comprising an electrical conductor, the control signal controlling the second electrode to move relatively to the first electrode until the electrical conductor electrically connects the first node with the second nod of the first electrode.

3. The charge pump according to claim 2, wherein the first electrode further comprises a first electrode plate insulated from the first node and the second node, and the second electrode further comprises a second electrode plate insulated from the electrical conductor.

4. The charge pump according to claim 3, wherein the second electrodes for each of MEMS switches of the first MEMS switches group are formed on the same first electrode plate, and the second electrodes for each of MEMS switches of the second MEMS switches group and the second electrodes for each of MEMS switches of the third MEMS switches group are formed on the same second electrode plate.

5. The charge pump according to claim 2, wherein each of MEMS switches of the first MEMS switches group is arranged in a vertically overlapped fashion, and each of MEMS switches of the third MEMS switches group and each of MEMS switches of the second MEMS switches group are arranged in a vertically overlapped fashion.

6. The charge pump according to claim 2, wherein each of MEMS switches of the first MEMS switches group, each of MEMS switches of the second MEMS switches group and each of MEMS switches of the third MEMS switches group are arranged in a vertically overlapped fashion.

7. The charge pump according to claim 1, wherein the at least one flying capacitor comprises one flying capacitor;
the first MEMS switches group comprises a first MEMS switch for connecting a first electrode plate of the flying capacitor with the first voltage input node, and a second MEMS switch for connecting a second electrode plate of the flying capacitor with the second voltage input node;
the second MEMS switches group comprises a third MEMS switch for connecting the second electrode plate of the flying capacitor with the first voltage input node; and
the third MEMS switches group comprises a forth MEMS switch for connecting the a first electrode plate of the energy reserve capacitor with the first electrode plate of the flying capacitor;
the first electrode plate of the energy reserve capacitor being connected with the voltage output node;
a second electrode plate of the energy reserve capacitor being connected with the second voltage input node.

8. The charge pump according to claim 7, wherein each of MEMS switches comprises a first electrode and a second electrode, the first electrode comprising a first node and a second node, the second electrode comprising an electrical conductor, the control signal controlling the second electrode to move relatively to the first electrode whereby the electrical conductor electrically connects the first node with the second nod of the first electrode.

9. The charge pump according to claim 8, wherein the first electrode further comprises a first electrode plate insulated from the first node and the second node, and the second electrode further comprises a second electrode plate insulated from the electrical conductor.

10. The charge pump according to claim 9, wherein the second electrodes for each of MEMS switches of the first MEMS switches group are formed on the same first electrode plate, and the second electrodes for each of MEMS switches of the second MEMS switches group and the second electrodes for each of MEMS switches of the third MEMS switches group are formed on the same second electrode plate.

11. The charge pump according to claim 8, wherein each of MEMS switches of the first MEMS switches group is arranged in a vertically overlapped fashion, and each of MEMS switches of the third MEMS switches group and each of MEMS switches of the second MEMS switches group are arranged in a vertically overlapped fashion.

12. The charge pump according to claim 8, wherein each of MEMS switches of the first MEMS switches group, each of MEMS switches of the second MEMS switches group and each of MEMS switches of the third MEMS switches group are arranged in a vertically overlapped fashion.

13. The charge pump according to claim 1, wherein the at least one flying capacitor comprises one flying capacitor;
the first MEMS switches group comprises a first MEMS switch for connecting a first electrode plate of the flying capacitor with the first voltage input node, and a second MEMS switch for connecting a second electrode plate of the flying capacitor with the second voltage input node;
the second MEMS switches group comprises a third MEMS switch for connecting the first electrode plate of the flying capacitor with the second voltage input node; and
the third MEMS switches group comprises a forth MEMS switch for connecting a first electrode plate of the energy reserve capacitor with the second electrode plate of the flying capacitor;
the first electrode plate of the energy reserve capacitor being connected with the voltage output node;
a second electrode plate of the energy reserve capacitor being connected with the second voltage input node.

14. The charge pump according to claim 13, wherein each of MEMS switches comprises a first electrode and a second electrode, the first electrode comprising a first node and a second node, the second electrode comprising an electrical conductor, the control signal controlling the second electrode to move relatively to the first electrode whereby the electrical conductor electrically connects the first node with the second nod of the first electrode.

15. The charge pump according to claim 14, wherein the first electrode further comprises a first electrode plate insulated from the first node and the second node, and the second electrode further comprises a second electrode plate insulated from the electrical conductor.

16. The charge pump according to claim 15, wherein the second electrodes for each of MEMS switches of the first MEMS switches group are formed on the same first electrode plate, and the second electrodes for each of MEMS switches of the second MEMS switches group and the second electrodes for each of MEMS switches of the third MEMS switches group are formed on the same second electrode plate.

17. The charge pump according to claim 14, wherein each of MEMS switches of the first MEMS switches group is arranged in a vertically overlapped fashion, and each of MEMS switches of the third MEMS switches group and each of MEMS switches of the second MEMS switches group are arranged in a vertically overlapped fashion.

18. The charge pump according to claim 14, wherein each of MEMS switches of the first MEMS switches group, each of MEMS switches of the second MEMS switches group and each of MEMS switches of the third MEMS switches group are arranged in a vertically overlapped fashion.

19. The charge pump according to claim 1, wherein the at least one flying capacitor comprises a first flying capacitor and a second flying capacitor;
the first MEMS switches group comprises a first MEMS switch for connecting a first electrode plate of the first flying capacitor with the first voltage input node, a second MEMS switch for connecting a second electrode plate of the first flying capacitor with a first electrode plate of the second flying capacitor, and a third MEMS switch for connecting a second electrode plate of the second flying capacitor with the second voltage input node;
the second MEMS switches group comprises a forth MEMS switch for connecting the second electrode plate of the first flying capacitor with the first voltage input node, and a fifth MEMS switch for connecting the second electrode plate of the second flying capacitor with the first voltage input node; and
the third MEMS switches group comprises a sixth MEMS switch for connecting a first electrode plate of the energy reserve capacitor with the first electrode plate of the first flying capacitor, and seventh MEMS switch for connecting the first electrode plate of the energy reserve capacitor with the first electrode plate of the second flying capacitor;
the first electrode plate of the energy reserve capacitor being connected with the voltage output node and a second electrode plate of the energy reserve capacitor being connected with the second voltage input node.

20. The charge pump according to claim 19, wherein each of MEMS switches comprises a first electrode and a second electrode, the first electrode comprising a first node and a second node, the second electrode comprising an electrical conductor, the control signal controlling the second electrode to move relatively to the first electrode whereby the electrical conductor electrically connects the first node with the second nod of the first electrode.

21. The charge pump according to claim 20, wherein the first electrode further comprises a first electrode plate insulated from the first node and the second node, and the second electrode further comprises a second electrode plate insulated from the electrical conductor.

22. The charge pump according to claim 21, wherein the second electrodes for each of MEMS switches of the first MEMS switches group are formed on the same first electrode plate, and the second electrodes for each of MEMS switches of the second MEMS switches group and the second electrodes for each of MEMS switches of the third MEMS switches group are formed on the same second electrode plate.

23. The charge pump according to claim 20, wherein each of MEMS switches of the first MEMS switches group is arranged in a vertically overlapped fashion, and each of MEMS switches of the third MEMS switches group and each of MEMS switches of the second MEMS switches group are arranged in a vertically overlapped fashion.

24. The charge pump according to claim 20, wherein each of MEMS switches of the first MEMS switches group, each of MEMS switches of the second MEMS switches group and each of MEMS switches of the third MEMS switches group are arranged in a vertically overlapped fashion.

25. The charge pump according to claim 1, wherein the second voltage input node is grounded.
